(19) United States
(12) Patent Application Publication
(10) Pub. No.: US 2019/0143236 A1
(43) Pub. Date: May 16, 2019

(54) MULTI-DIMENSIONAL SNAP CONNECTOR FOR A SNAP-TOGETHER ELECTRONIC TOY SET

(71) Applicant: ELENCO ELECTRONICS, INC., Wheeling, IL (US)

(72) Inventors: Gerald Joseph Cecchin, Buffalo Grove, IL (US); Marc C. Lehner, Glenview, IL (US); Alexander R. Matz, Wheeling, IL (US)

(21) Appl. No.: 15/810,813

(22) Filed: Nov. 13, 2017

(51) Int. Cl. A63H 33/04; H01R 39/64; A63H 33/10

(52) U.S. Cl. CPC A63H 33/042; A63H 33/101; H01R 39/64

(57) ABSTRACT

A snap-together electronic toy set includes a power source, a powered component, a connecting member, and a multi-dimensional connector. The multi-dimensional connector includes first and second surfaces disposed non-parallel to one another. The power source, the powered component, the connecting member, and the multi-dimensional connector are all electrically connected forming an electrical circuit. The power source electrically powers the powered component. The first surface of the multi-dimensional connector is snap-fittingly attached with the connecting member and the second surface of the multi-dimensional connector is snap-fittingly attached with the powered component. The multi-dimensional connector is configured to rotate relative to the connecting member to rotate the powered component relative to the connecting member.

### FIELD OF THE DISCLOSURE

The disclosure relates to multi-dimensional snap-fitting connectors which are configured to be used in snap-together electronic toy sets to allow the rotate-able, snap-fitting attachment of components in multiple dimensions.

### BACKGROUND

Snap-together electronic toy sets, such as educational toy sets, typically utilize a plurality of connecting members to complete a circuit in order to utilize a power source to power one or more components. However, the options for arranging the powered components are typically limited to two-dimensions and the powered components cannot be rotated.

A snap-together electronic toy set is needed to allow powered components to be rotate-ably and snap-fittingly arranged in three dimensions.

### SUMMARY

In one embodiment, a snap-together electronic toy set is disclosed. The snap-together electronic toy set includes a power source, a powered component, a connecting member, and a multi-dimensional connector. The multi-dimensional connector includes first and second surfaces disposed non-parallel to one another. The power source, the powered component, the connecting member, and the multi-dimensional connector are all electrically connected forming an electrical circuit. The power source electrically powers the powered component. The first surface of the multi-dimensional connector is snap-fittingly attached with the connecting member and the second surface of the multi-dimensional connector is snap-fittingly attached with the powered component. The multi-dimensional connector is configured to rotate relative to the connecting member to rotate the powered component relative to the connecting member.

In another embodiment, a snap-together electronic toy is disclosed. The snap-together electronic toy set includes a connecting member and a multi-dimensional connector. The connecting member includes a first snap-fitting member. The multi-dimensional connector includes first and second surfaces disposed non-parallel to one another. The first surface includes a second snap-fitting member and the second surface includes a third snap-fitting member. The second and third snap-fitting members are electrically connected. The first snap-fitting member of the connecting member is configured to snap-fittingly and rotate-ably attach to the second snap-fitting member of the first surface of the multi-dimensional connector to electrically connect the first and second snap-fitting members and to allow the multi-dimensional connector to rotate relative to the connecting member.

In still another embodiment, a method of using a snap-together electronic toy set is disclosed. In one step, a first surface of a multi-dimensional connector is snap-fittingly connected with a connecting member. In another step, a second surface of the multi-dimensional connector is snap-fittingly connected with a component. The first and second surfaces are disposed non-parallel to one another. In yet another step, the multi-dimensional connector and the connected component are rotated relative to the connecting member.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of one embodiment of a multi-dimensional connector;

FIG. 2 illustrates a perspective view of another embodiment of a multi-dimensional connector;

FIG. 3 illustrates a perspective view of another embodiment of a multi-dimensional connector;

FIG. 4 illustrates a perspective view of another embodiment of a multi-dimensional connector;

FIG. 5 illustrates a perspective view of another embodiment of a multi-dimensional connector;

FIG. 6 illustrates a perspective view of another embodiment of a multi-dimensional connector;

FIG. 7 illustrates a perspective view of another embodiment of a multi-dimensional connector;

FIG. 8 illustrates a perspective view of another embodiment of a multi-dimensional connector;

FIG. 9 illustrates a perspective view of another embodiment of a multi-dimensional connector;

FIG. 10 illustrates a perspective view of another embodiment of a multi-dimensional connector;

FIG. 11 illustrates a perspective view of another embodiment of a multi-dimensional connector;

FIG. 12 illustrates a perspective view of another embodiment of a multi-dimensional connector;

FIG. 13 illustrates a perspective view of another embodiment of a multi-dimensional connector;

FIG. 14 illustrates a perspective view of another embodiment of a multi-dimensional connector;

FIG. 15 illustrates a perspective view of another embodiment of a multi-dimensional connector;

FIG. 16 illustrates a perspective view of another embodiment of a multi-dimensional connector;

FIG. 17 illustrates a perspective view of another embodiment of a multi-dimensional connector;

FIG. 18 illustrates a perspective view of one embodiment of a snap-together electronic toy set;

FIG. 19 illustrates a perspective view of another embodiment of a snap-together electronic toy set;

FIG. 20 illustrates a front perspective view of another embodiment of a snap-together electronic toy set;

FIG. 21 illustrates a back perspective view of the snap-together electronic toy set of the embodiment of FIG. 20;

FIG. 22 illustrates a partial disassembled view of the snap-together electronic toy set of the embodiment of FIG. 20;

FIG. 23 illustrates a perspective view of another embodiment of a snap-together electronic toy set; and

FIG. 24 illustrates a flowchart of one embodiment of a method of using a snap-together electronic toy set.

### DETAILED DESCRIPTION

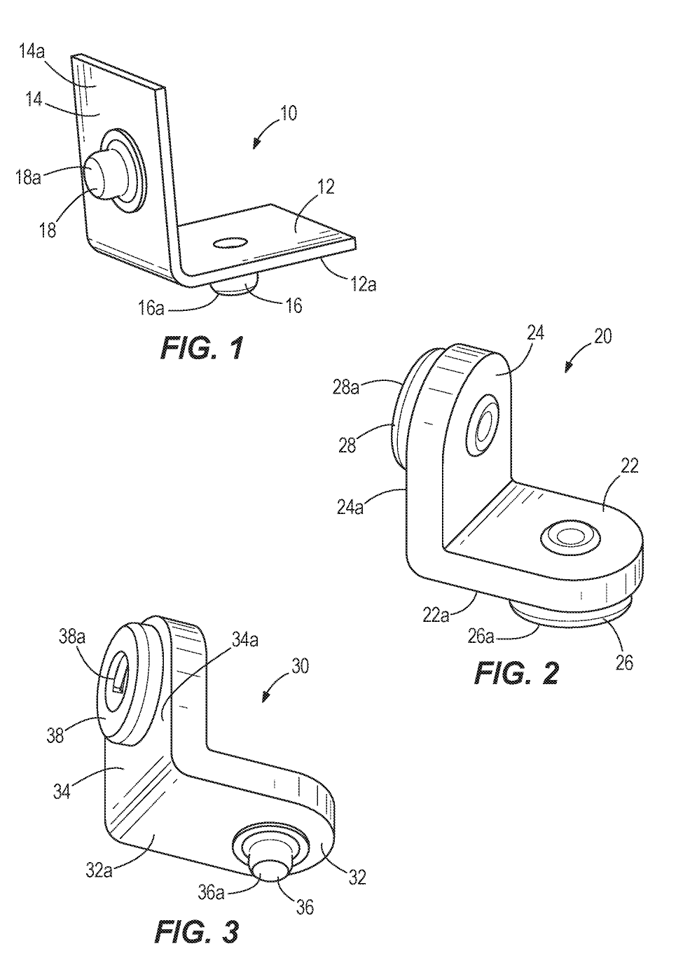

FIGS. 1-17 illustrate various embodiments of multi-dimensional connectors which may be used in snap-together electronic toys to assist children in building electronic circuits in multiple dimensions, and which further provide the ability to allow powered components, snap-fittingly and electrically connected with the multi-dimensional connectors, to be rotated. In other embodiments, any type of components may be connected with or to the multi-dimensional connectors in varying dimensions.

For purposes of this disclosure, the term “snap-together”, “snap-fit”, or “snap-fittingly” is defined as interlocking-components which are snapped together to be held in place as known in the art. This includes all variations in snap-fits including cantilever, torsional, annular, and all other types of snap-fits known to those of ordinary skill in the art. One typical snap-fit comprises interlocking female and male members which are configured to snap-together using a groove of the male member and a spring of the female member. However, in other embodiments the snap-fit of this disclosure may comprise any type of snap-fit known to those of ordinary skill in the art.

FIG. 1 illustrates a perspective view of one embodiment of a multi-dimensional connector 10. The multi-dimensional connector 10 comprises first and second surfaces 12 and 14 which are disposed non-parallel to one another. Snap-fitting members 16 and 18 are disposed in each of the first and second surfaces 12 and 14. Snap-fitting member 16 comprises a male snap-fitting member 16a disposed on side 12a of first surface 12. Snap-fitting member 18 comprises a male snap-fitting member 18a disposed on side 14a of second surface 14. The snap-fitting members 16 and 18 are electrically connected to one another due to the multi-dimensional connector 10 being made of an electrically conductive material such as metal or other electrically conductive material.

FIG. 2 illustrates a perspective view of another embodiment of a multi-dimensional connector 20. The multi-dimensional connector 20 comprises first and second surfaces 22 and 24 which are disposed non-parallel to one another. Snap-fitting members 26 and 28 are disposed in each of the first and second surfaces 22 and 24. Snap-fitting member 26 comprises a female snap-fitting member 26a disposed on side 22a of first surface 22. Snap-fitting member 28 comprises a female snap-fitting member 28a disposed on side 24a of second surface 24. The snap-fitting members 26 and 28 are electrically connected to one another due to the multi-dimensional connector 20 being made of an electrically conductive material such as metal or other electrically conductive material.

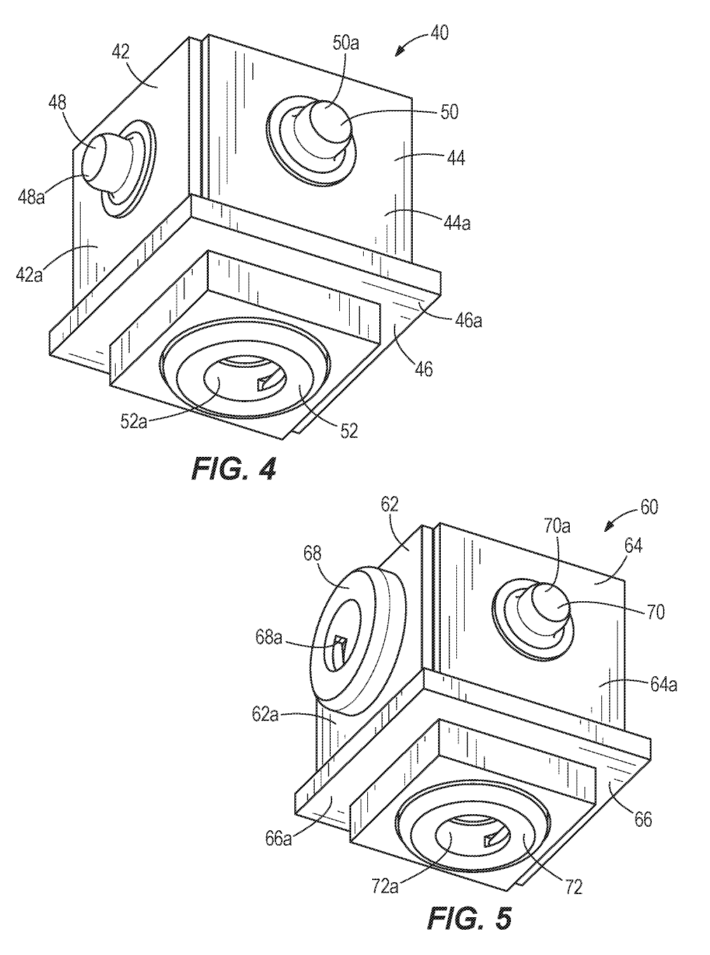

FIG. 3 illustrates a perspective view of another embodiment of a multi-dimensional connector 30. The multi-dimensional connector 30 comprises first and second surfaces 32 and 34 which are disposed non-parallel to one another. Snap-fitting members 36 and 38 are disposed in each of the first and second surfaces 32 and 34. Snap-fitting member 36 comprises a male snap-fitting member 36a disposed on side 32a of first surface 32. Snap-fitting member 38 comprises a female snap-fitting member 38a disposed on side 34a of second surface 34. The snap-fitting members 36 and 38 are electrically connected to one another due to the multi-dimensional connector 30 being made of an electrically conductive material such as metal or other electrically conductive material.

FIG. 4 illustrates a perspective view of another embodiment of a multi-dimensional connector 40. The multi-dimensional connector 40 comprises first, second, and third surfaces 42, 44, and 46 which are disposed non-parallel to one another. Snap-fitting members 48, 50, and 52 are disposed in each of the first, second, and third surfaces 42, 44, and 46. Snap-fitting member 48 comprises a male snap-fitting member 48a disposed on side 42a of first surface 42. Snap-fitting member 50 comprises a male snap-fitting member 50a disposed on side 44a of second surface 44. Snap-fitting member 52 comprises a female snap-fitting member 52a disposed on side 46a of third surface 46. The snap-fitting members 48, 50, and 52 are electrically connected to one another due to the multi-dimensional connector 40 being made of an electrically conductive material such as metal or other electrically conductive material.

FIG. 5 illustrates a perspective view of another embodiment of a multi-dimensional connector 60. The multi-dimensional connector 60 comprises first, second, and third surfaces 62, 64, and 66 which are disposed non-parallel to one another. Snap-fitting members 68, 70, and 72 are disposed in each of the first, second, and third surfaces 62, 64, and 66. Snap-fitting member 68 comprises a female snap-fitting member 68a disposed on side 62a of first surface 62. Snap-fitting member 70 comprises a male snap-fitting member 70a disposed on side 64a of second surface 64. Snap-fitting member 72 comprises a female snap-fitting member 72a disposed on side 66a of third surface 66. The snap-fitting members 68, 70, and 72 are electrically connected to one another due to the multi-dimensional connector 60 being made of an electrically conductive material such as metal or other electrically conductive material.

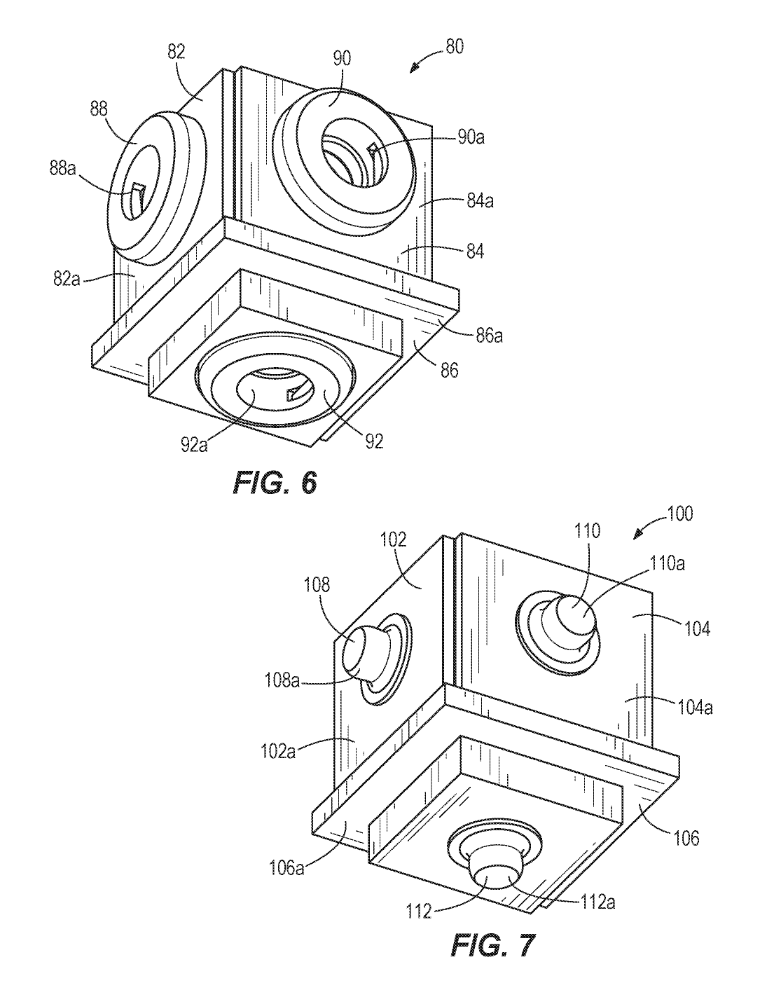

FIG. 6 illustrates a perspective view of another embodiment of a multi-dimensional connector 80. The multi-dimensional connector 80 comprises first, second, and third surfaces 82, 84, and 86 which are disposed non-parallel to one another. Snap-fitting members 88, 90, and 92 are disposed in each of the first, second, and third surfaces 82, 84, and 86. Snap-fitting member 88 comprises a female snap-fitting member 88a disposed on side 82a of first surface 82. Snap-fitting member 90 comprises a female snap-fitting member 90a disposed on side 84a of second surface 84. Snap-fitting member 92 comprises a female snap-fitting member 92a disposed on side 86a of third surface 86. The snap-fitting members 88, 90, and 92 are electrically connected to one another due to the multi-dimensional connector 80 being made of an electrically conductive material such as metal or other electrically conductive material.

FIG. 7 illustrates a perspective view of another embodiment of a multi-dimensional connector 100. The multi-dimensional connector 100 comprises first, second, and third surfaces 102, 104, and 106 which are disposed non-parallel to one another. Snap-fitting members 108, 110, and 112 are disposed in each of the first, second, and third surfaces 102, 104, and 106. Snap-fitting member 108 comprises a male snap-fitting member 108a disposed on side 102a of first surface 102. Snap-fitting member 110 comprises a male snap-fitting member 110a disposed on side 104a of second surface 104. Snap-fitting member 112 comprises a male snap-fitting member 112a disposed on side 106a of third surface 106. The snap-fitting members 108, 110, and 112 are electrically connected to one another due to the multi-dimensional connector 100 being made of an electrically conductive material such as metal or other electrically conductive material.

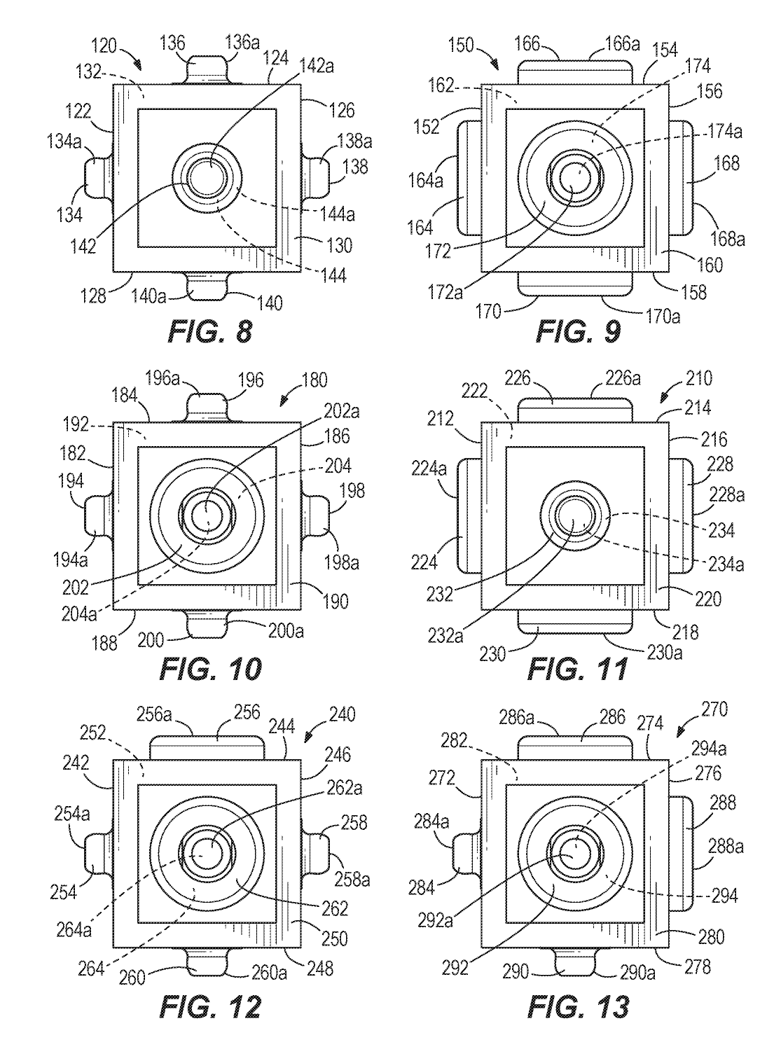

FIG. 8 illustrates a perspective view of another embodiment of a multi-dimensional connector 120. The multi-dimensional connector 120 is square-shaped and comprises first, second, third, fourth, fifth, and sixth surfaces 122, 124, 126, 128, 130, and 132 (which has a dotted lead-line indicating it is hidden from view opposed to surface 130) which are disposed non-parallel to one another. Snap-fitting members 134, 136, 138, 140, 142, and 144 (which has a dotted lead-line indicating it is hidden from view on hidden surface 132) are disposed in each of the first, second, third, fourth, fifth, and sixth surfaces 122, 124, 126, 128, 130, and 132. Snap-fitting member 134 comprises a male snap-fitting member 134a disposed on first surface 122. Snap-fitting member 136 comprises a male snap-fitting member 136a disposed on second surface 124. Snap-fitting member 138 comprises a male snap-fitting member 138a disposed on third surface 126. Snap-fitting member 140 comprises a male snap-fitting member 140a disposed on fourth surface 128. Snap-fitting member 142 comprises a male snap-fitting member 142a disposed on fifth surface 130. Snap-fitting member 144 comprises a male snap-fitting member 144a (which has a dotted lead-line indicating it is hidden from view on hidden surface 132) disposed on sixth surface 132. In another embodiment, snap-fitting member 144 may comprise a female snap-fitting member. The snap-fitting members 134, 136, 138, 140, 142, and 144 are electrically connected to one another due to the multi-dimensional connector 120 being made of an electrically conductive material such as metal or other electrically conductive material.

FIG. 9 illustrates a perspective view of another embodiment of a multi-dimensional connector 150. The multi-dimensional connector 150 is square-shaped and comprises first, second, third, fourth, fifth, and sixth surfaces 152, 154, 156, 158, 160, and 162 (which has a dotted lead-line indicating it is hidden from view opposed to surface 160) which are disposed non-parallel to one another. Snap-fitting members 164, 166, 168, 170, 172, and 174 (which has a dotted lead-line indicating it is hidden from view on hidden surface 162) are disposed in each of the first, second, third, fourth, fifth, and sixth surfaces 152, 154, 156, 158, 160, and 162. Snap-fitting member 164 comprises a female snap-fitting member 164a disposed on first surface 152. Snap-fitting member 166 comprises a female snap-fitting member 166a disposed on second surface 154. Snap-fitting member 168 comprises a female snap-fitting member 168a disposed on third surface 156. Snap-fitting member 170 comprises a female snap-fitting member 170a disposed on fourth surface 158. Snap-fitting member 172 comprises a female snap-fitting member 172a disposed on fifth surface 160. Snap-fitting member 174 comprises a female snap-fitting member 174a (which has a dotted lead-line indicating it is hidden from view on hidden surface 162) disposed on sixth surface 162. In another embodiment, snap-fitting member 174 may comprise a male snap-fitting member. The snap-fitting members 164, 166, 168, 170, 172, and 174 are electrically connected to one another due to the multi-dimensional connector 150 being made of an electrically conductive material such as metal or other electrically conductive material.

FIG. 10 illustrates a perspective view of another embodiment of a multi-dimensional connector 180. The multi-dimensional connector 180 is square-shaped and comprises first, second, third, fourth, fifth, and sixth surfaces 182, 184, 186, 188, 190, and 192 (which has a dotted lead-line indicating it is hidden from view opposed to surface 190) which are disposed non-parallel to one another. Snap-fitting members 194, 196, 198, 200, 202, and 204 (which has a dotted lead-line indicating it is hidden from view on hidden surface 192) are disposed in each of the first, second, third, fourth, fifth, and sixth surfaces 182, 184, 186, 188, 190, and 192. Snap-fitting member 194 comprises a male snap-fitting member 194a disposed on first surface 182. Snap-fitting member 196 comprises a male snap-fitting member 196a disposed on second surface 184. Snap-fitting member 198 comprises a male snap-fitting member 198a disposed on third surface 186. Snap-fitting member 200 comprises a male snap-fitting member 200a disposed on fourth surface 188. Snap-fitting member 202 comprises a female snap-fitting member 202a disposed on fifth surface 190. Snap-fitting member 204 comprises a female snap-fitting member 204a (which has a dotted lead-line indicating it is hidden from view on hidden surface 192) disposed on sixth surface 192. In another embodiment, snap-fitting member 204 may comprise a male snap-fitting member. The snap-fitting members 194, 196, 198, 200, 202, and 204 are electrically connected to one another due to the multi-dimensional connector 180 being made of an electrically conductive material such as metal or other electrically conductive material.

FIG. 11 illustrates a perspective view of another embodiment of a multi-dimensional connector 210. The multi-dimensional connector 210 is square-shaped and comprises first, second, third, fourth, fifth, and sixth surfaces 212, 214, 216, 218, 220, and 222 (which has a dotted lead-line indicating it is hidden from view opposed to surface 220) which are disposed non-parallel to one another. Snap-fitting members 224, 226, 228, 230, 232, and 234 (which has a dotted lead-line indicating it is hidden from view on hidden surface 222) are disposed in each of the first, second, third, fourth, fifth, and sixth surfaces 212, 214, 216, 218, 220, and 222. Snap-fitting member 224 comprises a female snap-fitting member 224a disposed on first surface 212. Snap-fitting member 226 comprises a female snap-fitting member 226a disposed on second surface 214. Snap-fitting member 228 comprises a female snap-fitting member 228a disposed on third surface 216. Snap-fitting member 230 comprises a female snap-fitting member 230a disposed on fourth surface 218. Snap-fitting member 232 comprises a male snap-fitting member 232a disposed on fifth surface 220. Snap-fitting member 234 comprises a male snap-fitting member 234a (which has a dotted lead-line indicating it is hidden from view on hidden surface 222) disposed on sixth surface 222. In another embodiment, snap-fitting member 234 may comprise a female snap-fitting member. The snap-fitting members 224, 226, 228, 230, 232, and 234 are electrically connected to one another due to the multi-dimensional connector 210 being made of an electrically conductive material such as metal or other electrically conductive material.

FIG. 12 illustrates a perspective view of another embodiment of a multi-dimensional connector 240. The multi-dimensional connector 240 is square-shaped and comprises first, second, third, fourth, fifth, and sixth surfaces 242, 244, 246, 248, 250, and 252 (which has a dotted lead-line indicating it is hidden from view opposed to surface 250) which are disposed non-parallel to one another. Snap-fitting members 254, 256, 258, 260, 262, and 264 (which has a dotted lead-line indicating it is hidden from view on hidden surface 252) are disposed in each of the first, second, third, fourth, fifth, and sixth surfaces 242, 244, 246, 248, 250, and 252. Snap-fitting member 254 comprises a male snap-fitting member 254a disposed on first surface 242. Snap-fitting member 256 comprises a female snap-fitting member 256a disposed on second surface 244. Snap-fitting member 258 comprises a male snap-fitting member 258a disposed on third surface 246. Snap-fitting member 260 comprises a male snap-fitting member 260a disposed on fourth surface 248. Snap-fitting member 262 comprises a female snap-fitting member 262a disposed on fifth surface 250. Snap-fitting member 264 comprises a female snap-fitting member 264a (which has a dotted lead-line indicating it is hidden from view on hidden surface 252) disposed on sixth surface 252. In another embodiment, snap-fitting member 264 may comprise a male snap-fitting member. The snap-fitting members 254, 256, 258, 260, 262, and 264 are electrically connected to one another due to the multi-dimensional connector 240 being made of an electrically conductive material such as metal or other electrically conductive material.

FIG. 13 illustrates a perspective view of another embodiment of a multi-dimensional connector 270. The multi-dimensional connector 270 is square-shaped and comprises first, second, third, fourth, fifth, and sixth surfaces 272, 274, 276, 278, 280, and 282 (which has a dotted lead-line indicating it is hidden from view opposed to surface 280) which are disposed non-parallel to one another. Snap-fitting members 284, 286, 288, 290, 292, and 294 (which has a dotted lead-line indicating it is hidden from view on hidden surface 282) are disposed in each of the first, second, third, fourth, fifth, and sixth surfaces 272, 274, 276, 278, 280, and 282. Snap-fitting member 284 comprises a male snap-fitting member 284a disposed on first surface 272. Snap-fitting member 286 comprises a female snap-fitting member 286a disposed on second surface 274. Snap-fitting member 288 comprises a female snap-fitting member 288a disposed on third surface 276. Snap-fitting member 290 comprises a male snap-fitting member 290a disposed on fourth surface 278. Snap-fitting member 292 comprises a female snap-fitting member 292a disposed on fifth surface 280. Snap-fitting member 294 comprises a female snap-fitting member 294a (which has a dotted lead-line indicating it is hidden from view on hidden surface 282) disposed on sixth surface 282. In another embodiment, snap-fitting member 294 may comprise a male snap-fitting member. The snap-fitting members 284, 286, 288, 290, 292, and 294 are electrically connected to one another due to the multi-dimensional connector 270 being made of an electrically conductive material such as metal or other electrically conductive material.

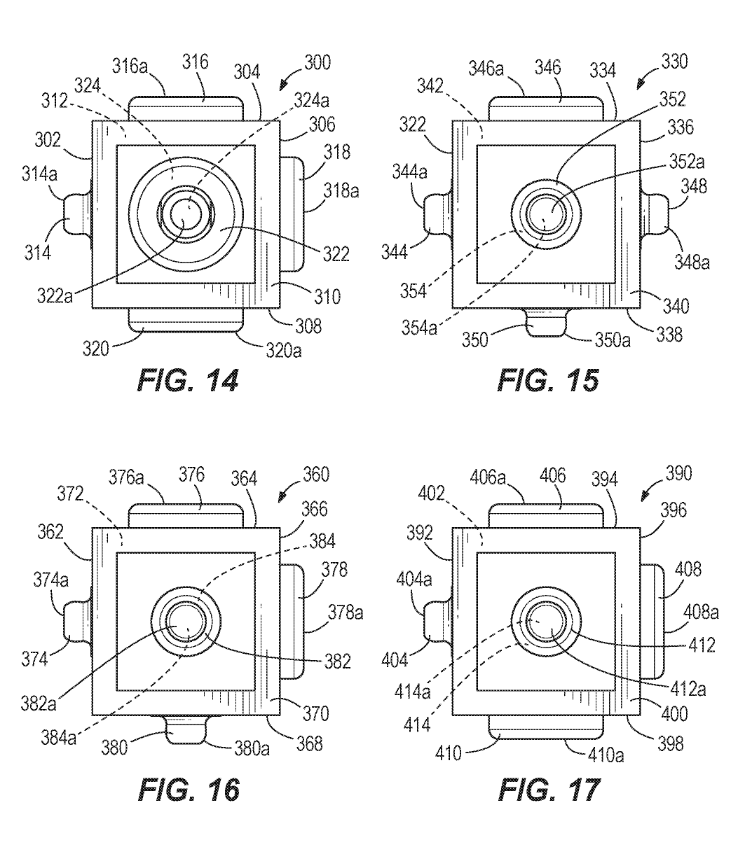

FIG. 14 illustrates a perspective view of another embodiment of a multi-dimensional connector 300. The multi-dimensional connector 300 is square-shaped and comprises first, second, third, fourth, fifth, and sixth surfaces 302, 304, 306, 308, 310, and 312 (which has a dotted lead-line indicating it is hidden from view opposed to surface 310) which are disposed non-parallel to one another. Snap-fitting members 314, 316, 318, 320, 322, and 324 (which has a dotted lead-line indicating it is hidden from view on hidden surface 312) are disposed in each of the first, second, third, fourth, fifth, and sixth surfaces 302, 304, 306, 308, 310, and 312. Snap-fitting member 314 comprises a male snap-fitting member 314a disposed on first surface 302. Snap-fitting member 316 comprises a female snap-fitting member 316a disposed on second surface 304. Snap-fitting member 318 comprises a female snap-fitting member 318a disposed on third surface 306. Snap-fitting member 320 comprises a female snap-fitting member 320a disposed on fourth surface 308. Snap-fitting member 322 comprises a female snap-fitting member 322a disposed on fifth surface 310. Snap-fitting member 324 comprises a female snap-fitting member 324a (which has a dotted lead-line indicating it is hidden from view on hidden surface 312) disposed on sixth surface 312. In another embodiment, snap-fitting member 324 may comprise a male snap-fitting member. The snap-fitting members 314, 316, 318, 320, 322, and 324 are electrically connected to one another due to the multi-dimensional connector 300 being made of an electrically conductive material such as metal or other electrically conductive material.

FIG. 15 illustrates a perspective view of another embodiment of a multi-dimensional connector 330. The multi-dimensional connector 330 is square-shaped and comprises first, second, third, fourth, fifth, and sixth surfaces 332, 334, 336, 338, 340, and 342 (which has a dotted lead-line indicating it is hidden from view opposed to surface 340) which are disposed non-parallel to one another. Snap-fitting members 344, 346, 348, 350, 352, and 354 (which has a dotted lead-line indicating it is hidden from view on hidden surface 342) are disposed in each of the first, second, third, fourth, fifth, and sixth surfaces 332, 334, 336, 338, 340, and 342. Snap-fitting member 344 comprises a male snap-fitting member 344a disposed on first surface 332. Snap-fitting member 346 comprises a female snap-fitting member 346a disposed on second surface 334. Snap-fitting member 348 comprises a male snap-fitting member 348a disposed on third surface 336. Snap-fitting member 350 comprises a male snap-fitting member 350a disposed on fourth surface 338. Snap-fitting member 352 comprises a male snap-fitting member 352a disposed on fifth surface 340. Snap-fitting member 354 comprises a male snap-fitting member 354a (which has a dotted lead-line indicating it is hidden from view on hidden surface 342) disposed on sixth surface 342. In another embodiment, snap-fitting member 354 may comprise a female snap-fitting member. The snap-fitting members 344, 346, 348, 350, 352, and 354 are electrically connected to one another due to the multi-dimensional connector 330 being made of an electrically conductive material such as metal or other electrically conductive material.

FIG. 16 illustrates a perspective view of another embodiment of a multi-dimensional connector 360. The multi-dimensional connector 360 is square-shaped and comprises first, second, third, fourth, fifth, and sixth surfaces 362, 364, 366, 368, 370, and 372 (which has a dotted lead-line indicating it is hidden from view opposed to surface 370) which are disposed non-parallel to one another. Snap-fitting members 374, 376, 378, 380, 382, and 384 (which has a dotted lead-line indicating it is hidden from view on hidden surface 372) are disposed in each of the first, second, third, fourth, fifth, and sixth surfaces 362, 364, 366, 368, 370, and 372. Snap-fitting member 374 comprises a male snap-fitting member 374a disposed on first surface 362. Snap-fitting member 376 comprises a female snap-fitting member 376a disposed on second surface 364. Snap-fitting member 378 comprises a female snap-fitting member 378a disposed on third surface 366. Snap-fitting member 380 comprises a male snap-fitting member 380a disposed on fourth surface 368. Snap-fitting member 382 comprises a male snap-fitting member 382a disposed on fifth surface 370. Snap-fitting member 384 comprises a male snap-fitting member 384a (which has a dotted lead-line indicating it is hidden from view on hidden surface 372) disposed on sixth surface 372. In another embodiment, snap-fitting member 384 may comprise a female snap-fitting member. The snap-fitting members 374, 376, 378, 380, 382, and 384 are electrically connected to one another due to the multi-dimensional connector 360 being made of an electrically conductive material such as metal or other electrically conductive material.

FIG. 17 illustrates a perspective view of another embodiment of a multi-dimensional connector 390. The multi-dimensional connector 390 is square-shaped and comprises first, second, third, fourth, fifth, and sixth surfaces 392, 394, 396, 398, 400, and 402 (which has a dotted lead-line indicating it is hidden from view opposed to surface 400) which are disposed non-parallel to one another. Snap-fitting members 404, 406, 408, 410, 412, and 414 (which has a dotted lead-line indicating it is hidden from view on hidden surface 402) are disposed in each of the first, second, third, fourth, fifth, and sixth surfaces 392, 394, 396, 398, 400, and 402. Snap-fitting member 404 comprises a male snap-fitting member 404a disposed on first surface 392. Snap-fitting member 406 comprises a female snap-fitting member 406a disposed on second surface 394. Snap-fitting member 408 comprises a female snap-fitting member 408a disposed on third surface 396. Snap-fitting member 410 comprises a female snap-fitting member 410a disposed on fourth surface 398. Snap-fitting member 412 comprises a male snap-fitting member 412a disposed on fifth surface 400. Snap-fitting member 414 comprises a male snap-fitting member 414a (which has a dotted lead-line indicating it is hidden from view on hidden surface 402) disposed on sixth surface 402. In another embodiment, snap-fitting member 414 may comprise a female snap-fitting member. The snap-fitting members 404, 406, 408, 410, 412, and 414 are electrically connected to one another due to the multi-dimensional connector 390 being made of an electrically conductive material such as metal or other electrically conductive material.

In other embodiments, the multi-dimensional connectors of FIGS. 1-17 may further vary in the number, shape, configuration, and alignment of non-parallel surfaces they contain, and in the number, type, configuration, and location of snap-fitting members that they contain. For instance, in the embodiments of FIGS. 8-17 one of the surfaces may be removed so that the multi-dimensional connectors contain five non-parallel surfaces. In still other embodiments, the entire structure of the multi-dimensional connectors does not have to be electrically conductive as long as its snap-fitting members are electrically conductive.

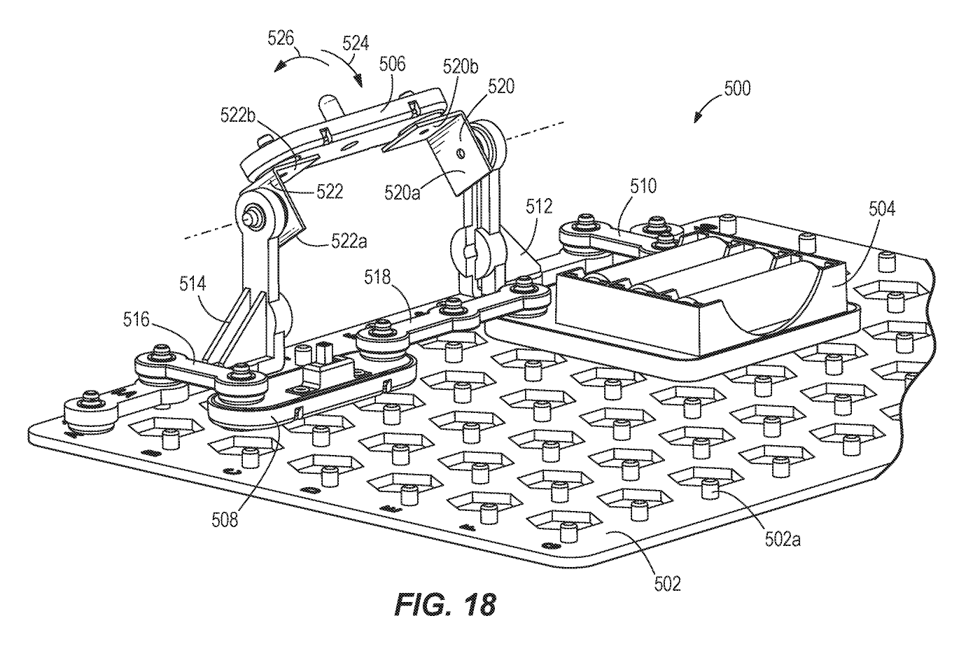

FIG. 18 illustrates a perspective view of one embodiment of a snap-together electronic toy set 500. The snap-together electronic toy set 500 comprises grid 502, power source 504, powered components 506 and 508, connectors 510, 512, 514, 516, and 518, and multi-dimensional connectors 520 and 522. Grid 502 comprises pegs 502a. Power source 504, powered component 508, and connectors 512 and 514 are snap-fittingly attached to pegs 502a of grid 502. The snap-fits of power source 504 are electrically conductive. The snap-fits of powered components 506 and 508 are electrically conductive. Each of the connectors 510, 512, 514, 516, and 518 contain electrically conductive wires electrically connecting the snap-fits of each respective connector. Connectors 510 and 516 each comprise two snap-fits which are electrically connected. Connectors 512 and 514 are L-shaped connectors which each comprise three snap-fits which are electrically connected. Connector 518 comprises three snap-fits which are electrically connected. The snap-fits of the multi-dimensional connectors 520 and 522 are electrically connected due to the multi-dimensional connectors 520 and 522 being made of electrically conductive material.

The power source 504, powered components 506 and 508, connectors 510, 512, 514, 516, and 518, and multi-dimensional connectors 520 and 522 are all electrically connected through their respective snap-fits to form a complete circuit. The electrical signal travels from the power source 504, through connector 510, through connector 512, through multi-dimensional connector 520, through powered component 506, through multi-dimensional connector 522, through connector 514, through connector 516, through powered component 508, through connector 518, and back to power source 504 to complete the circuit. In such manner the power source 504 powers powered components 506 and 508.

Power source 504 comprises a battery. In other embodiments, the power source 504 may comprise a solar panel, an adapter, a generator, or another power source. Powered component 506 comprises a light. In other embodiments, powered component 506 may comprise a capacitor, a resistor, a diode, an inductor, a transistor, a semiconductor, a triode, a motor, a fan, a sound emitter, a speaker, a buzzer, a bell, an alarm, a microphone, a switch, an integrated circuit, a computer chip, an amplifier, a modulator, a computer, a computer interface, a telephone interface, a motion device, a display, a visual device, an audio device, a communication device, a reed switch, a sound device, or another type of powered component. Powered component 508 comprises a switch to turn the circuit on and off to turn the light 506 on and off. In other embodiments, powered component 508 may comprise a capacitor, a resistor, a diode, an inductor, a transistor, a semiconductor, a triode, a motor, a fan, a sound emitter, a speaker, a buzzer, a bell, an alarm, a microphone, a light, an integrated circuit, a computer chip, an amplifier, a modulator, a computer, a computer interface, a telephone interface, a motion device, a display, a visual device, an audio device, a communication device, a reed switch, a sound device, or another type of powered component.

Surface 520a of multi-dimensional connector 520 is snap-fittingly and rotate-ably attached to connector 512. Surface 520b of multi-dimensional connector 520 is snap-fittingly attached to powered component 506. Surface 522a of multi-dimensional connector 522 is snap-fittingly and rotate-ably attached to connector 514. Surface 522b of multi-dimensional connector 522 is snap-fittingly attached to powered component 506. Due to the rotate-able attachment of multi-dimensional connectors 520 and 522 to connectors 512 and 514, attached powered component 506 can be manually rotated in directions 524 and 526 with the multi-dimensional connectors 520 and 522 relative to connectors 512 and 514 while being electrically powered by the power source 504.

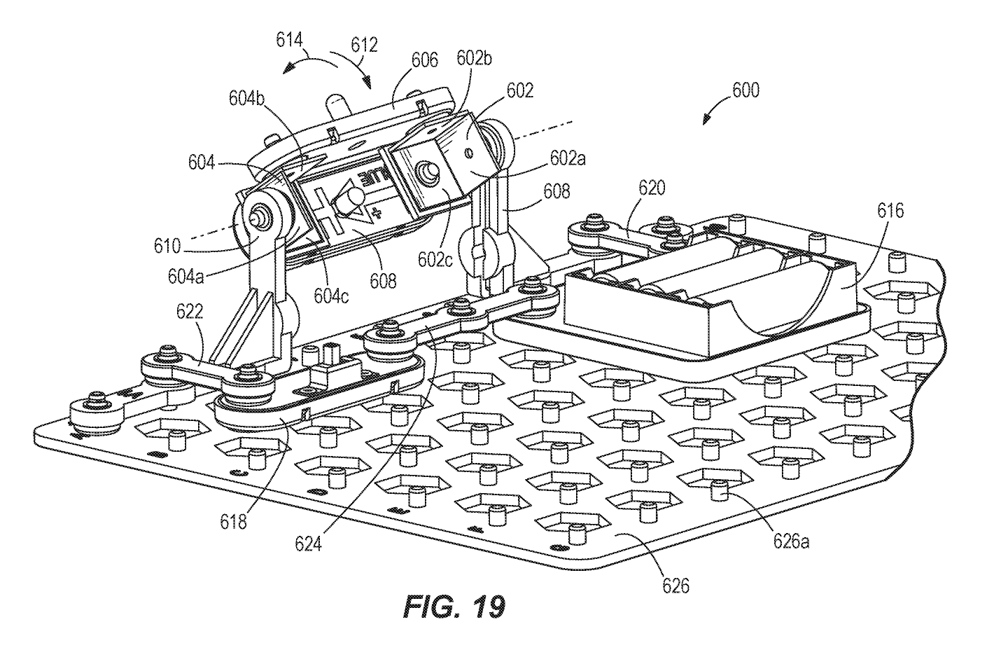

FIG. 19 illustrates a perspective view of another embodiment of a snap-together electronic toy set 600. The only difference between the snap-together electronic toy set 600 of the embodiment of FIG. 19 and the snap-together electronic toy set 500 of the embodiment of FIG. 18 is that the two-surface multi-dimensional connectors 520 and 522 snap-fittingly connected to power component 506 of FIG. 18 have been replaced with three-surface multi-dimensional connectors 602 and 604 snap-fittingly connected to power components 606 and 608 as shown in FIG. 19.

Surface 602a of multi-dimensional connector 602 is snap-fittingly and rotate-ably attached to connector 608. Surface 602b of multi-dimensional connector 602 is snap-fittingly attached to powered component 606. Surface 602c of multi-dimensional connector 602 is snap-fittingly attached to powered component 608. Surface 604a of multi-dimensional connector 604 is snap-fittingly and rotate-ably attached to connector 610. Surface 604b of multi-dimensional connector 604 is snap-fittingly attached to powered component 606. Surface 604c of multi-dimensional connector 604 is snap-fittingly attached to powered component 608. Due to the rotate-able attachment of multi-dimensional connectors 602 and 604 to connectors 608 and 610, attached powered components 606 and 608 can be manually rotated in directions 612 and 614 with the multi-dimensional connectors 602 and 604 relative to connectors 608 and 610 while being electrically powered by the power source 616.

Power source 616, powered component 618, and connectors 608 and 610 are snap-fittingly attached to pegs 626a of grid 626. The power source 616, powered components 606, 608, and 618, connectors 620, 608, 610, 622, and 624, and multi-dimensional connectors 602 and 604 are all electrically connected through their respective snap-fits to form a complete circuit. The electrical signal travels from the power source 616, through connector 620, through connector 608, through multi-dimensional connector 602, through powered components 606 and 608, through multi-dimensional connector 604, through connector 610, through connector 622, through powered component 618, through connector 624, and back to power source 616 to complete the circuit. In such manner the power source 616 powers powered components 606, 608, and 618.

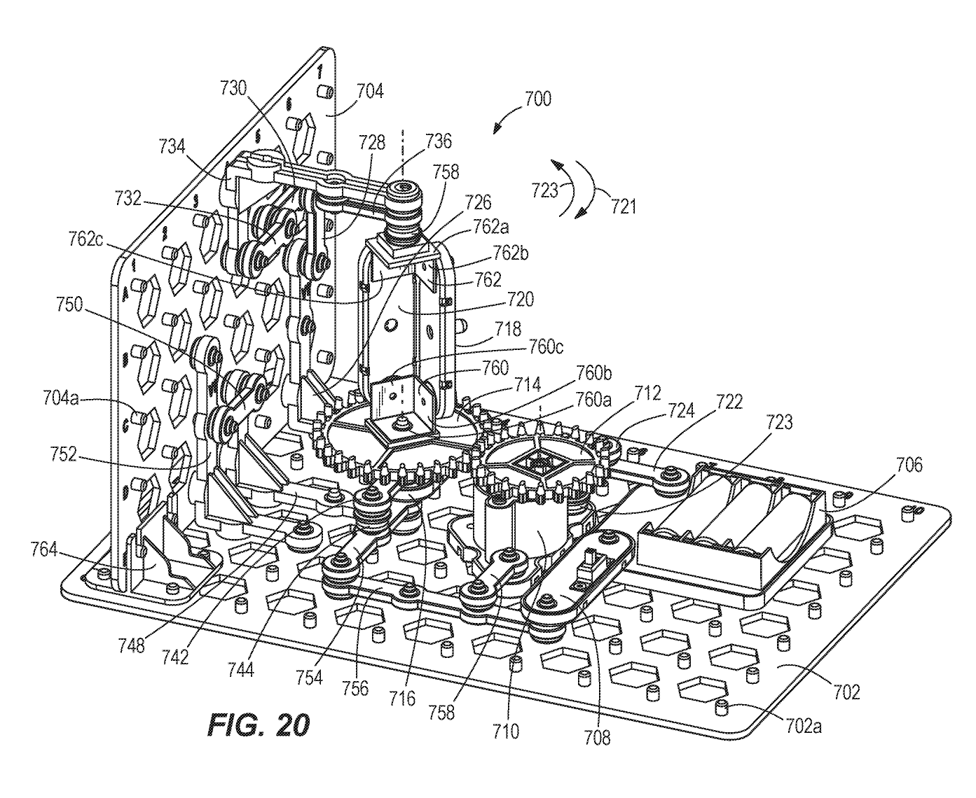

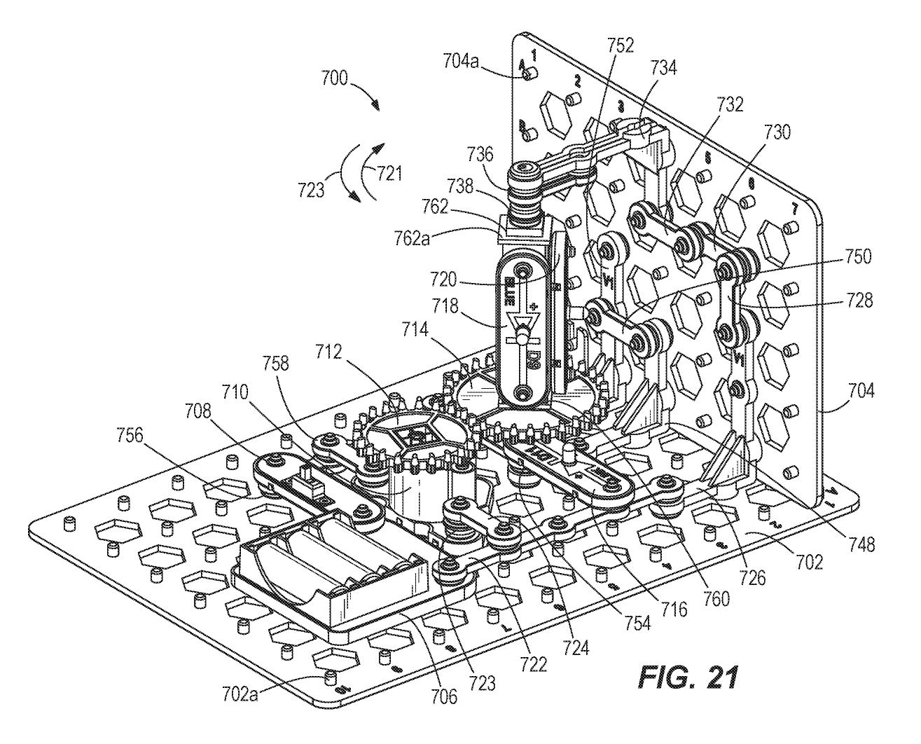

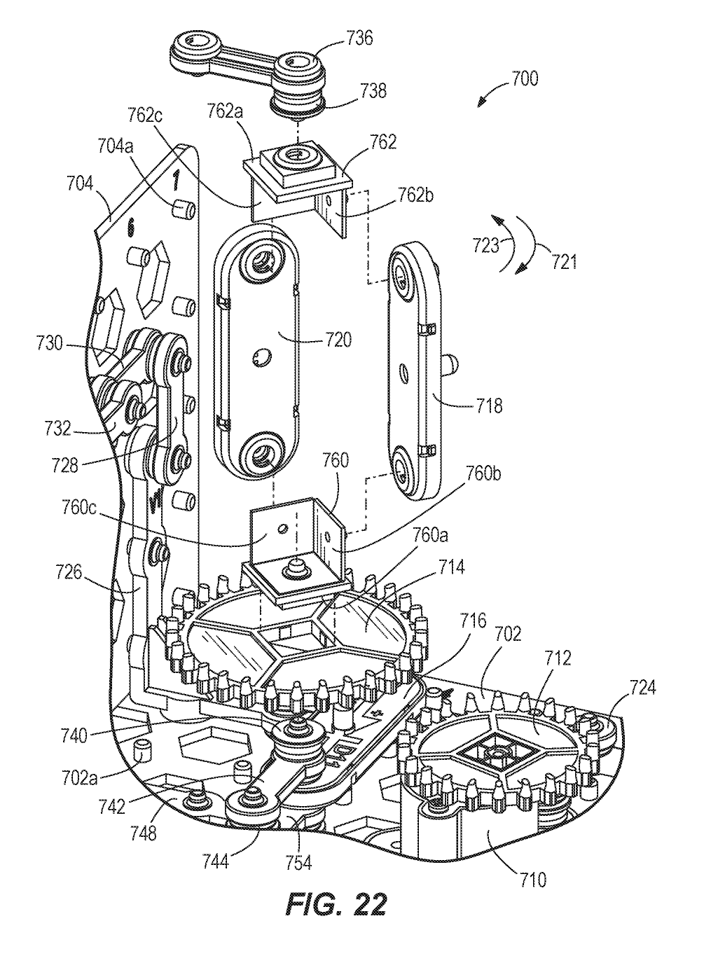

FIG. 20 illustrates a front perspective view of another embodiment of a snap-together electronic toy set 700. FIG. 21 illustrates a back perspective view of the snap-together electronic toy set 700 of the embodiment of FIG. 20. FIG. 22 illustrates a partial disassembled view of the snap-together electronic toy set 700 of the embodiment of FIG. 20. As shown in FIGS. 20-22, the snap-together electronic toy set 700 comprises grids 702 and 704, power source 706, powered components 708, 710, 712, 714, 716, 718, and 720, connectors 722, 723, 724, 726, 728, 730, 732, 734, 736, 738, 740, 742, 744, 748, 750, 752, 754, 756, and 758, multi-dimensional connectors 760 and 762, and grid-support 764. Grid 702 comprises pegs 702a. Grid 704 comprises pegs 704a. Power source 706, powered component 710, and connectors 726, 730, 734, 748, 752, and 756, and grid-support 764 are snap-fittingly attached collectively to pegs 702a of grid 702 and to pegs 704a of grid 704.

The snap-fits of power source 706 are electrically conductive. The snap fits of powered components 708, 710, 716, 718, and 720 are electrically conductive. Each of the connectors 722, 724, 726, 728, 730, 732, 734, 736, 742, 748, 750, 752, 754, 756, and 758 contain electrically conductive wires electrically connecting the snap-fits of each respective connector. Connectors 723, 738, 740, and 744 each comprise one snap-fit which are electrically conductive. Connectors 724, 728, 730, 732, 736, 742, 750, and 758 each comprise two snap-fits which are electrically connected. Connectors 726, 734, 748, and 752 are L-shaped connectors which each comprise three snap-fits which are electrically connected. Connector 754 comprises three snap-fits which are electrically connected. Connector 756 comprises four snap-fits which are electrically connected. Connector 722 comprises five snap-fits which are electrically connected. The snap-fits of the multi-dimensional connectors 760 and 762 are electrically connected due to the multi-dimensional connectors 760 and 762 being made of electrically conductive material.

The power source 706, powered components 708, 710, 716, 718, and 720, connectors 722, 723, 724, 726, 728, 730, 732, 734, 736, 738, 740, 742, 744, 748, 750, 752, 754, 756, and 758, and multi-dimensional connectors 760 and 762 are all electrically connected through their respective snap-fits to form a complete circuit. The electrical signal travels from the power source 706, through the connectors 722, 723, 724, 726, 728, 730, 732, 734, 736, 738, 740, 742, 744, 748, 750, 752, 754, 756, and 758, and multi-dimensional connectors 760 and 762, to the powered components 708, 710, 716, 718, and 720 to power the powered components 708, 710, 716, 718, and 720.

Power source 706 comprises a battery. In other embodiments, the power source 706 may comprise a solar panel, an adapter, a generator, or another power source. Powered components 716, 718, and 720 comprise lights. In other embodiments, powered components 716, 718, and 720 may comprise capacitors, resistors, diodes, inductors, transistors, semiconductors, triodes, motors, fans, sound emitters, speakers, buzzers, bells, alarms, microphones, switches, integrated circuits, computer chips, amplifiers, modulators, computers, computer interfaces, telephone interfaces, motion devices, displays, visual devices, audio devices, communication devices, reed switches, a sound devices, or other types of powered components. Powered component 708 comprises a switch to turn the circuit on and off to turn the powered components 710, 716, 718, and 720 on and off. In other embodiments, powered component 708 may comprise a capacitor, a resistor, a diode, an inductor, a transistor, a semiconductor, a triode, a motor, a fan, a sound emitter, a speaker, a buzzer, a bell, an alarm, a microphone, a light, an integrated circuit, a computer chip, an amplifier, a modulator, a computer, a computer interface, a telephone interface, a motion device, a display, a visual device, an audio device, a communication device, a reed switch, a sound device, or another type of powered component.

Powered component 710 comprises a motor to rotate powered component 712. In other embodiments, powered component 710 may comprise a capacitor, a resistor, a diode, an inductor, a transistor, a semiconductor, a triode, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, a reed switch, a sound device, or another type of powered component. Powered components 712 and 714 comprise mechanically powered gears with gear 712 being mechanically rotated by motor 710, which is electrically powered by power source 706, and gear 712 in turn mechanically rotating gear 714. In other embodiments, powered components 712 and 714 may comprise capacitors, resistors, diodes, inductors, transistors, semiconductors, triodes, motors, fans, sound emitters, speakers, buzzers, bells, alarms, microphones, switches, integrated circuits, computer chips, amplifiers, modulators, computers, computer interfaces, telephone interfaces, motion devices, displays, visual devices, audio devices, communication devices, reed switches, sound devices, or other types of electrically or mechanically powered components.

Surface 760a of multi-dimensional connector 760 is snap-fittingly and rotate-ably attached to connector 740 and is further attached to powered component 714 so that multi-dimensional connector 760 rotates with powered component 714. Surface 760b of multi-dimensional connector 760 is snap-fittingly attached to powered component 718 so that powered component 718 rotates with multi-dimensional connector 760. Surface 760c of multi-dimensional connector 760 is snap-fittingly attached to powered component 720 so that powered component 720 rotates with multi-dimensional connector 760. Surface 762a of multi-dimensional connector 762 is snap-fittingly and rotate-ably attached to connector 738. Surface 762b of multi-dimensional connector 762 is snap-fittingly attached to powered component 718 so that multi-dimensional connector 762 rotates with powered component 718. Surface 762c of multi-dimensional connector 762 is snap-fittingly attached to powered component 720 so that multi-dimensional connector 762 rotates with powered component 720. Due to the rotate-able attachment of multi-dimensional connectors 760 and 762 to connectors 740 and 738 along with the attachment of powered component 714 to multi-dimensional connector 760, attached powered components 718 and 720 are automatically rotated in either of directions 721 or 723 with multi-dimensional connectors 760 and 762 and powered component 714 when powered component 714 is mechanically rotated by powered component 712 which is mechanically rotated by powered component 710 which is electrically powered by power source 706.

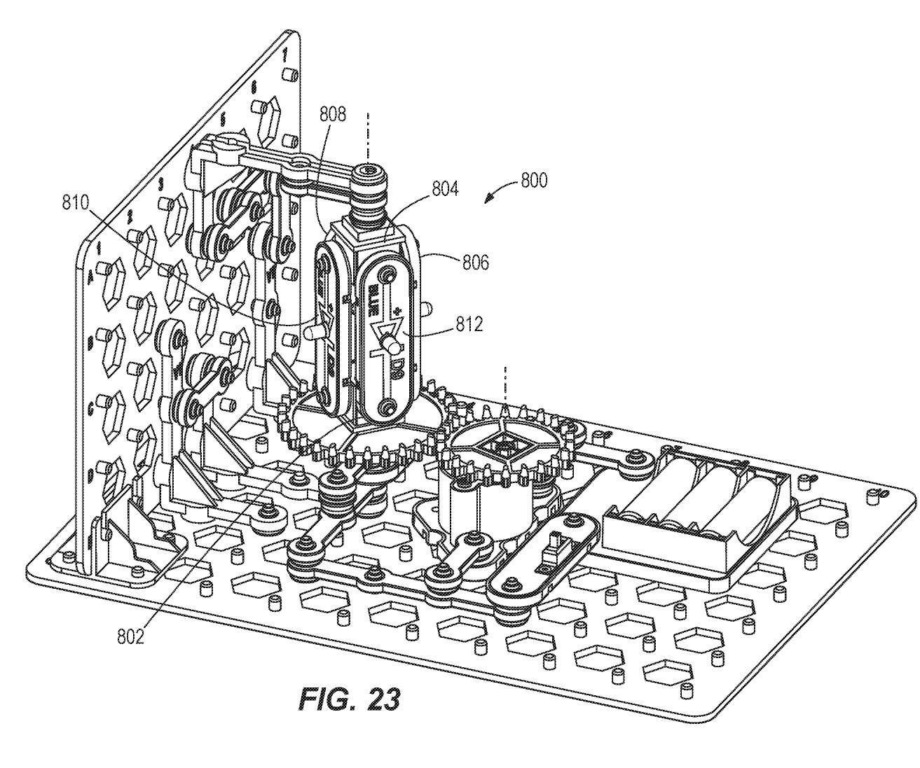

FIG. 23 illustrates a perspective view of another embodiment of a snap-together electronic toy set 800. The only difference between the snap-together electronic toy set 700 of the embodiment of FIG. 20 and the snap-together electronic toy set 800 of the embodiment of FIG. 23 is that the three-surface multi-dimensional connectors 760 and 762 snap-fittingly connected to power components 718 and 720 of FIG. 20 have been replaced with six-surface multi-dimensional connectors 802 and 804 snap-fittingly connected to power components 806, 808, 810 and 812 as shown in FIG. 23.

In other embodiments, the snap-together electronic toys 500, 600, 700, and 800 of FIGS. 18-23 may be modified in their configuration, orientation, components, structure, and function. For instance, the multi-dimensional connectors 520, 522, 602, 604, 760, 762, 802, and 804 of the snap-together electronic toys 500, 600, 700, and 800 of FIGS. 18-23 may vary in the number, shape, configuration, and alignment of non-parallel surfaces they contain, and in the number, type, configuration, and location of snap-fitting members that they contain. In other embodiments, the snap-together electronic toys 500, 600, 700, and 800 of FIGS. 18-23 may be modified further.

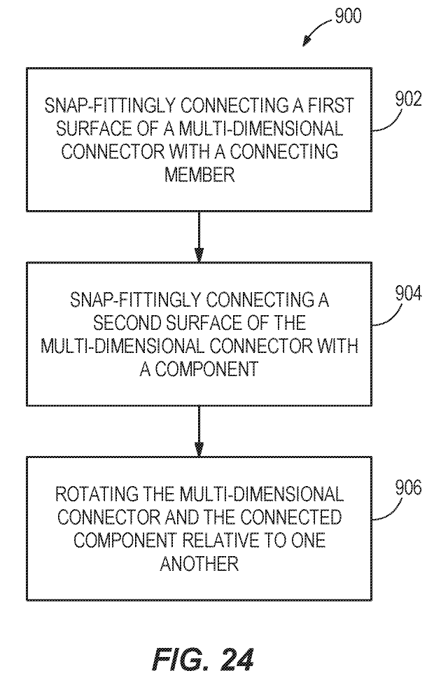

FIG. 24 illustrates a flowchart of one embodiment of a method 900 of using a snap-together electronic toy set. In step 902, a first surface of a multi-dimensional connector is snap-fittingly connected with a connecting member. In step 904, a second surface of the multi-dimensional connector is snap-fittingly connected with a component. The first and second surfaces of the multi-dimensional connector are disposed non-parallel to one another. In step 906, the multi-dimensional connector and the connected component are rotated relative to one another.

In one embodiment, the component comprises a powered component, and the method 900 further comprises electrically connecting the connecting member, the multi-dimensional connector, the powered component, and a power source to form an electrical circuit in order to power the powered component with the power source.

In another embodiment, the method further comprises manually rotating the multi-dimensional connector and the connected component relative to the connecting member.

In still another embodiment, the component comprises a powered component, and the method 900 further comprises: attaching a second powered component to the multi-dimensional connector; and electrically connecting the connecting member, the multi-dimensional connector, the powered component, and the power source to form an electrical circuit in order to power the second powered component by the power source so that the second powered component automatically rotates the multi-dimensional connector and the connected powered component relative to the connecting member. The powered component may comprise a light and the second powered component may comprises a gear.

In yet another embodiment, the component comprises a powered component, the multi-dimensional connector comprises three, four, five, or six surfaces disposed non-parallel to one another, and the method 900 further comprises: snap-fittingly attaching at least two of the three, four, five, or six surfaces of the multi-dimensional connector to a plurality of powered components; electrically connecting the connecting member, the multi-dimensional connector, the plurality of powered components, and the power source to form an electrical circuit in order to power the plurality of powered components with the power source; and rotating the multi-dimensional connector and the connected plurality of powered components relative to the connecting member.

In other embodiments, one or more steps of the method 900 of FIG. 24 may be modified in substance or in order, one or more steps of the method 900 of FIG. 24 may not be followed, or one or more additional steps may be added to the method 900 of FIG. 24.

The disclosure allows powered components to be rotate-ably and snap-fittingly arranged in three dimensions.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A snap-together electronic toy set comprising:
a power source;
a powered component;
a connecting member; and
a multi-dimensional connector comprising first and second surfaces disposed non-parallel to one another;
wherein the power source, the powered component, the connecting member, and the multi-dimensional connector are all electrically connected forming an electrical circuit whereby the power source electrically powers the powered component;
wherein the first surface of the multi-dimensional connector is snap-fittingly attached at a first snap-fit location with the connecting member and the second surface of the multi-dimensional connector is snap-fittingly attached at a second snap-fit location with the powered component, the multi-dimensional connector comprising only one electrically conductive path along which current from the power source flows from the first snap-fit location of the multi-dimensional connector to the second snap-fit location of the multi-dimensional connector;
wherein the multi-dimensional connector is configured to rotate relative to the connecting member to rotate the powered component relative to the connecting member.

2. The snap-together electronic toy set of claim 1 wherein the powered component comprises a light.

3. The snap-together electronic toy set of claim 1 wherein the power source comprises a battery, a solar panel, an adapter, or a generator.

4. The snap-together electronic toy set of claim 1 wherein the multi-dimensional connector is configured to be manually rotated relative to the connecting member to manually rotate the powered component relative to the connecting member.

5. The snap-together electronic toy set of claim 1 further comprising a second powered component attached to the multi-dimensional connector, wherein the multi-dimensional connector is configured to be automatically rotated, by the second powered component which is powered by the power source, relative to the connecting member to automatically rotate the powered component relative to the connecting member.

6. The snap-together electronic toy set of claim 5 wherein the second powered component comprises a gear.

7. The snap-together electronic toy set of claim 1 wherein the multi-dimensional connector comprises three, four, five, or six surfaces disposed non-parallel to one another, at least two of the three, four, five, or six surfaces of the multi-dimensional connector snap-fittingly attached to a plurality of powered components, the plurality of powered components electrically powered by the power source, the multi-dimensional connector configured to rotate relative to the connecting member to rotate the plurality of powered components relative to the connecting member.

8. A snap-together electronic toy set comprising:
a connecting member comprising a first snap-fitting member; and
a multi-dimensional connector comprising first and second surfaces disposed non-parallel to one another, the first surface comprising a second snap-fitting member and the second surface comprising a third snap-fitting member, the multi-dimensional connector comprising only one electrically conductive path electrically connecting the second and third snap-fitting members;
wherein the first snap-fitting member of the connecting member is configured to snap-fittingly and rotate-ably attach to the second snap-fitting member of the first surface of the multi-dimensional connector to electrically connect the first and second snap-fitting members and to allow the multi-dimensional connector to rotate relative to the connecting member.

9. The snap-together electronic toy set of claim 8 wherein the multi-dimensional connector further comprises a third surface disposed non-parallel to the first and second surfaces, the third surface comprising a fourth snap-fitting member, the second, third, and fourth snap-fitting members electrically connected.

10. The snap-together electronic toy set of claim 9 wherein the multi-dimensional connector further comprises a fourth surface disposed non-parallel to the first, second, and third surfaces, the fourth surface comprising a fifth snap-fitting member, the second, third, fourth, and fifth snap-fitting members electrically connected.

11. The snap-together electronic toy set of claim 10 wherein the multi-dimensional connector further comprises a fifth surface disposed non-parallel to the first, second, third, and fourth surfaces, the fifth surface comprising a sixth snap-fitting member, the second, third, fourth, fifth, and sixth snap-fitting members electrically connected.

12. The snap-together electronic toy set of claim 11 wherein the multi-dimensional connector further comprises a sixth surface disposed non-parallel to the first, second, third, fourth, and fifth surfaces, the sixth surface comprising a seventh snap-fitting member, the second, third, fourth, fifth, sixth, and seventh snap-fitting members electrically connected.

13. The snap-together electronic toy set of claim 8 further comprising a powered component comprising a fourth snap-fitting member, wherein the fourth snap-fitting member of the powered component is configured to snap-fittingly attach to the third snap-fitting member of the second surface of the multi-dimensional connector to electrically connect the third and fourth snap-fitting members and to allow the powered component to rotate, with the multi-dimensional connector, relative to the connecting member.

14. The snap-together electronic toy set of claim 8 further comprising a powered component and a power source, the power source configured to power the powered component to rotate, the multi-dimensional connector configured to attach to the powered component to rotate with the powered component.

15. A method of using a snap-together electronic toy set comprising:
snap-fittingly connecting a first surface of a multi-dimensional connector with a connecting member at a first snap-fit location;
snap-fittingly connecting a second surface of the multi-dimensional connector with a component at a second snap-fit location, wherein the first and second surfaces are disposed non-parallel to one another;
rotating the multi-dimensional connector and the connected component relative to the connecting member; and
conducting electricity from the first snap-fit location to the second snap-fit location over only one electrically conductive path of the multi-dimensional connector.

16. The method of claim 15 wherein the component comprises a powered component, and further comprising electrically connecting the connecting member, the multi-dimensional connector, the powered component, and a power source to form an electrical circuit in order to power the powered component with the power source.

17. The method of claim 15 further comprising manually rotating the multi-dimensional connector and the connected component relative to the connecting member.

18. The method of claim 16 further comprising attaching a second powered component to the multi-dimensional connector, and electrically connecting the connecting member, the multi-dimensional connector, the powered component, and the power source to form the electrical circuit in order to power the second powered component by the power source so that the second powered component automatically rotates the multi-dimensional connector and the connected powered component relative to the connecting member.

19. The method of claim 18 wherein the powered component comprises a light and the second powered component comprises a gear.

20. The method of claim 16 wherein the multi-dimensional connector comprises three, four, five, or six surfaces disposed non-parallel to one another, and further comprising snap-fittingly attaching at least two of the three, four, five, or six surfaces of the multi-dimensional connector to a plurality of powered components, electrically connecting the connecting member, the multi-dimensional connector, the plurality of powered components, and the power source to form the electrical circuit in order to power the plurality of powered components with the power source, and rotating the multi-dimensional connector and the connected plurality of powered components relative to the connecting member.

21. The snap-together electronic toy set of claim 1 wherein the multi-dimensional connector comprises a spring.

22. The snap-together electronic toy set of claim 5 wherein the multi-dimensional connector is fixedly attached to the second powered component so that there is no relative movement between the multi-dimensional connector and the second powered component.

23. The snap-together electronic toy set of claim 6 further comprising a third powered component comprising a second gear, the gear engaged with the second gear, wherein the second gear is configured to automatically rotate the gear.

24. The snap-together electronic toy set of claim 1 further comprising a second multi-dimensional connector comprising third and fourth surfaces disposed non-parallel to one another, and a second connecting member, wherein the power source, the powered component, the connecting member, the second connecting member, the multi-dimensional connector, and the second multi-dimensional connector are all electrically connected forming the electrical circuit, the third surface of the second multi-dimensional connector is snap-fittingly attached with the second connecting member and the fourth surface of the second multi-dimensional connector is snap-fittingly attached with the powered component, and the second multi-dimensional connector is configured to rotate relative to the second connecting member to rotate the powered component relative to the second connecting member.

25. The snap-together electronic toy set of claim 8 wherein at least one of the second snap-fitting member and the third snap-fitting member comprises a spring.

26. The method of claim 15 wherein the snap-fittingly connecting the first surface of the multi-dimensional connector with the connecting member comprises using a spring of the multi-dimensional connector.

27. The method of claim 15 wherein the snap-fittingly connecting the second surface of the multi-dimensional connector with the component comprises using a spring of the multi-dimensional connector.

28. The method of claim 18 wherein the attaching the second powered component to the multi-dimensional connector comprises fixedly attaching the second powered component to the multi-dimensional connector so that there is no relative movement between the multi-dimensional connector and the second powered component.

29. The method of claim 19 further comprising engaging a third powered component, comprising a second gear, with the gear, and automatically rotating the gear with the second gear.

30. The method of claim 15 further comprising snap-fittingly connecting a third surface of a second multi-dimensional connector with a second connecting member; snap-fittingly connecting a fourth surface of the second multi-dimensional connector with the component, wherein the third and fourth surfaces are disposed non-parallel to one another; and rotating the second multi-dimensional connector and the connected component relative to the second connecting member.
